(19) United States
(12) Patent Application Publication
(10) Pub. No.: US 2005/0144787 A1
(43) Pub. Date: Jul. 7, 2005

(54) Multi-blade utility knife handle

(76) Inventor: Joseph Macri, Rome, NY (US)

Correspondence Address: DAVID GIGLIO Esq., 231 Elizabeth Street, Utica, NY, 13501, US

(21) Appl. No.: 10/746,359

(22) Filed: Dec. 29, 2003

(51) Int. Cl. B26B 1/00

(52) U.S. Cl. 30/142; 30/162

(57) ABSTRACT

There is provide a utility knife handle having a plurality of blade openings. The blades can be alternated between a sheathed and an unsheathed position. Alternatively the blades can be statically positioned in an unsheathed position. Blade storage is accomplished internal to mating casing sections.

This invention claims priority from a provisional application filed on Jan. 13, 2003 and a second provisional application filed on Jan. 21, 2003.

### FIELD OF THE INVENTION

The present invention relates generally to the field of hand held tool and, more particularly, to a hand held utility knife.

### BACKGROUND OF THE PRESENT INVENTION

Utility knifes are valuable tools for a wide array of projects. These knifes are used for opening sealed boxes, trimming plaster board and installing roofing shingles, to name a few.

Utility knifes come in several forms. In some knifes, the blade is always in an unsheathed position. In other knifes, the blade can be in either a sheathed or unsheathed position. These knifes are shown and described in U.S. Pat. No. 4,586,256 to Weimann, U.S. Pat. No. 5,025,558 to Gilbert, U.S. Pat. No. 4,621,425 to Stoutenberg and U.S. Pat. No. 5,406,707 to Owens et al. each of which is hereby incorporated by reference.

Referring now to FIG. 1, a utility knife handle 11 usually includes a pair of mating case sections 13 and 15 and a blade retainer 17. Spare blades are stored inside of a storage recess 19 created by the mating case sections 13 and 15.

Typically the case sections are mated using a machine screw 21. To replace a dull blade, the case sections 13 and 15 must be unmated, a spare blade installed and then the case sections 13 and 15 are re-mated. This takes some time and progress stops for the time it takes to complete this replacement.

Roofers generally require two types of blades in their knife, a straight blade and a hook blade. Thus, they are required to either carry two knifes, which takes up space in the tool pouch, or change blades frequently. Even if they carry two knifes, it is difficult to determine which knife they are pulling from the pouch. They must first move the blade to the unsheathed position to determine if they removed the required knife.

### SUMMARY OF THE PRESENT INVENTION

It is an object of the present invention to improve the art of utility knives.

It is another object of the present invention to improve the field of construction and home maintenance.

It is a further object of the present invention to provide a utility knife that provides longer use before a blade change is required.

It is a feature of the present invention to provide a utility knife that accommodates for use at least two utility knife blades.

It is another feature of the present invention to provide a utility knife that accommodates for use a trapezoidal shaped blade and a hook shaped blade.

These and other objects and features are provided in accordance with the present invention wherein there is provided a utility knife handle includes a first case having a longitudinal axis, a second case which mates with said first case to form a handle, a first blade opening disposed at a first longitudinal end of said handle, a second blade opening disposed at a second longitudinal end of said handle, a first blade carrier disposed adjacent to the first longitudinal end of said handle for securing a first blade and a second blade carrier disposed adjacent to the second longitudinal end of said handle for securing a second blade.

The utility knife handle further includes a blade storage well or storage recess for storing at least one extra blade. In one embodiment, the blade carriers include a slidable blade track such that a blade can be alternated between a sheathed and unsheathed position. Alternatively, the blade carrier may be a static arrangement so that the blade is always in an unsheathed position.

The second casing may be one member, two members or even three members.

In yet another embodiment, the utility knife handle includes a housing having a longitudinal axis, a plurality of blade openings disposed in the housing and a blade carrier adjacent to each of said plurality of blade openings. The utility knife handle further includes an intermediate casing disposed between a pair of outer casings.

The housing further includes a first longitudinal end and a second longitudinal end wherein a first blade opening is disposed at the first longitudinal end and a second blade opening is disposed at the second longitudinal end.

It is also possible for a third blade opening to be disposed at the first longitudinal end adjacent to the first blade opening. It is further possible for a fourth blade opening to be disposed at the second longitudinal end adjacent to the second blade opening.

The housing can include a first outer case, a second outer case and an intermediate casing member having two sides, the intermediate casing member being disposed between the first and second casings, and wherein blade storage means are disposed on each side of the intermediate casing member.

Alternatively, the housing can include a first outer case, a second outer case and an intermediate casing member having two sides. The intermediate casing member is disposed between the first and second casings wherein the intermediate casing includes a blade storage well disposed therethrough.

### BRIEF DESCRIPTION OF THE DRAWINGS

Further objects of the present invention will become apparent from the following description of the preferred embodiments with reference to the accompanying drawings, in which:

FIG. 1 is a side elevation view of a utility knife handle of the prior art;

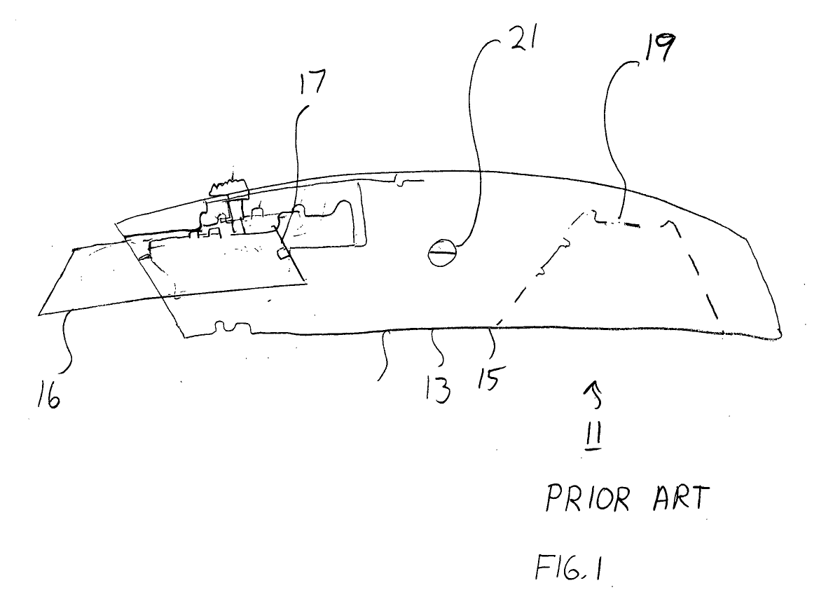

FIG. 2 is a side elevation view of a preferred embodiment of a first casing of the utility knife handle of the present invention;

FIG. 3 is a side elevation view of a preferred embodiment of a second casing of the utility knife handle that mates with the first casing of FIG. 2 of the present invention;

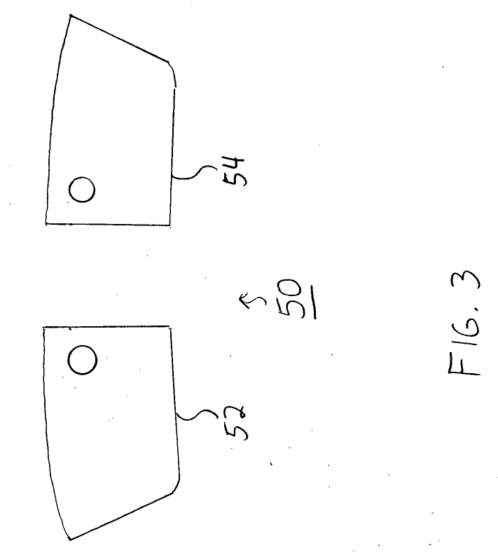

FIG. 4 is a side elevation view of the preferred embodiment of the utility knife handle of the present invention showing the first casing of FIG. 2 mated with the second casing of FIG. 3;

FIG. 5 is a side elevation view an alternative embodiment of a first casing of the utility knife handle of the present invention;

FIG. 6 is a side elevation view of the utility knife in accordance with the first casing depicted in FIG. 5;

FIG. 7 is a top perspective view of another alternative embodiment of the utility knife of the present invention; and

FIG. 8 is a top perspective view of yet another alternative embodiment of the utility knife of the present invention.

### DETAILED DESCRIPTION OF THE PRESENT INVENTION

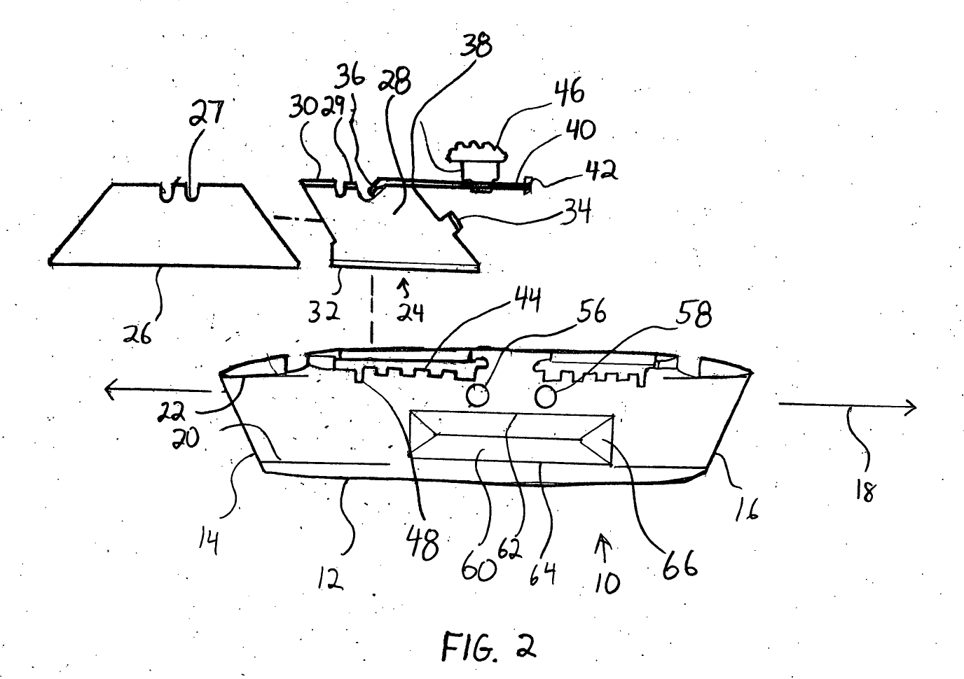

Turning now to FIG. 2, there is shown a first embodiment of the utility knife handle 10 of the present invention. A first case 12 includes equal and opposite ends 14 and 16 along its longitudinal axis 18. Therefore only one end will be described herein.

The first case 12 includes equidistant guideways 20 and 22 which keep a blade carriage 24 in track a blade 26 moves between the sheathed and unsheathed position. The blade carriage 24 includes an upright planar blade support 28, an upper flange 30, a lower flange 32 and a rearward flange 34 each of which cooperate to keep the blade 26 in the blade carriage 24. The blade carriage 24 also includes an angular retention tab 36 which keeps the blade 26 in an upright position against the planar blade support 28. This is all known to one skilled in the art as are various other methods and apparatus for securing and retracting a blade.

The upper portion 38 of the blade carriage 24 includes a rearwardly disposed resilient member 40. A laterally projecting latching tab 42 fits inside of one of a series of notches 44 disposed in the first case 12. The latching tab 42 becomes disengaged from the notch 44 when a thumb button 46 is depressed. The blade carriage 24 now easily slides inside of the guideways 20 and 22 so that the blade 26 can be extended or retracted.

A downwardly disposed stop 48 prevents the blade 26 from sliding too far from the utility knife handle 10 by contacting an upper edge 49 of the blade carriage 24 as the blade 26 is being extended. The blade 26 includes an upper notch 27 which mates with a laterally extending tab 29 of the blade carriage 24. The laterally extending tab 29 prevents the blade 26 from forward movement relative to the blade carriage 24. Again this is all known to one skilled in the art as are various other methods and apparatus for securing and retracting a blade.

A second case 50 which mates with the first case includes two equal and opposite partial case members 52 and 54. A first partial case member 52 is secured to the first case 12 using a machine screw 71 which mates with a first female receptacle 56 disposed in the first case 12. A second partial case member 54 is secured to the first case 12 using the machine screw 71 which mates with a second female receptacle 58 disposed in the first case 12.

Where there was a storage recess 19 in the prior art, there are now two female receptacles 56 and 58 disposed in the first case 12. To allow spare blade storage, the first case 12 of the present invention includes a laterally disposed storage blade well 60 having an upper wall 62, a lower wall 64 and opposing side walls 66. Storage blades fit along their planar sides inside of the storage blade well 60. To replace a worn blade both partial case members 52 and 54 must be removed.

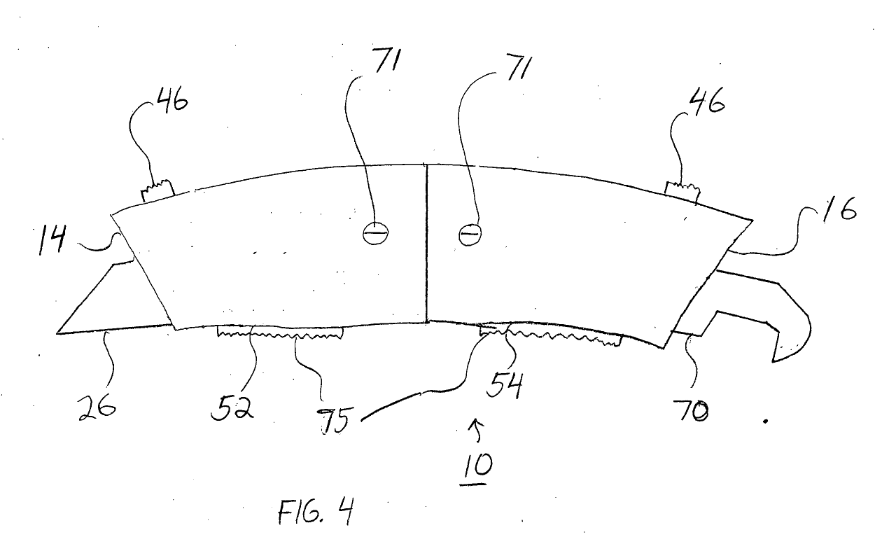

FIG. 4 depicts the knife handle 10 having the blade 26 extending from the first end 14 and a hook blade 70 extending from the second end 16. A pair of rubber grips 75 extend downwardly from the knife handle 10.

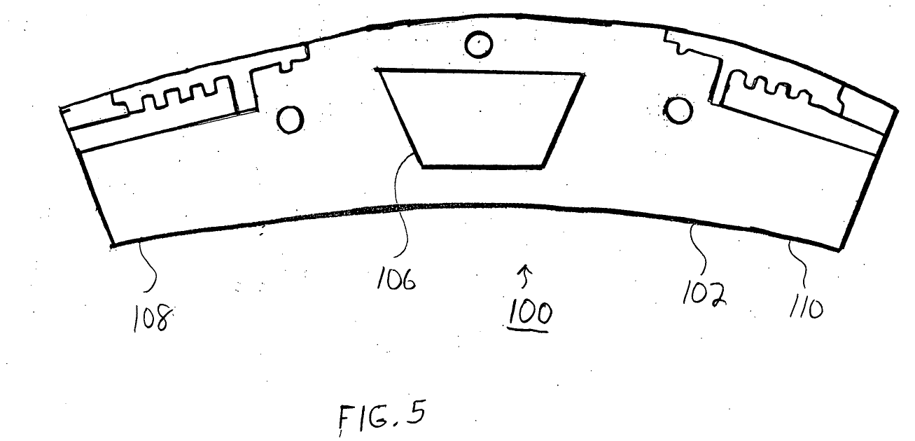

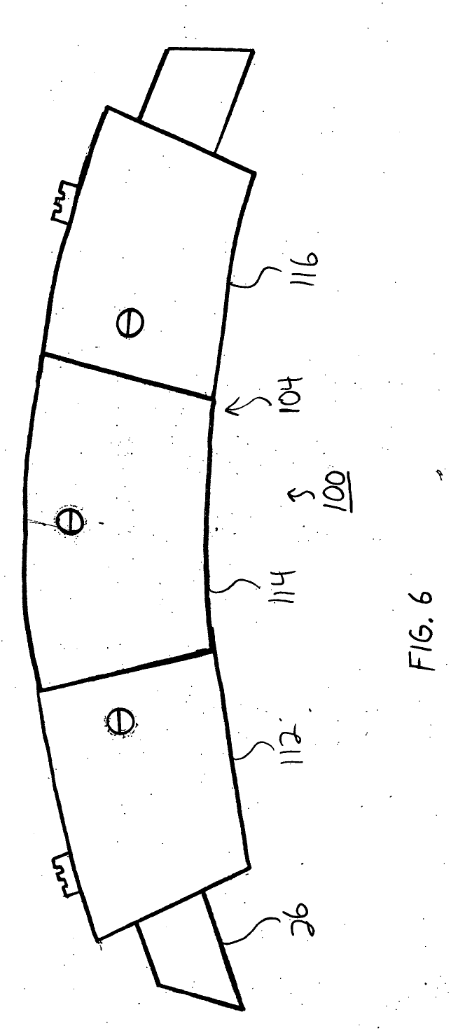

Looking now at FIGS. 5 and 6, there is shown another embodiment of utility knife handle 100 of the present invention. Elongated first and second cases 102 and 104 allows the storage recess 106 of the prior art to be disposed between two blade functioning ends 108 and 110.

For any embodiment of a knife handle as depicted and described herein, the blade retention, extension and retraction function as previously described or in any manner as apparent to one skilled in the art.

The second case 104 can be in one piece, two partial case members or, as depicted in FIG. 6, three partial case members 112, 114 and 116. With reference to FIG. 6, partial case members 112 and 114 are removed when changing the blade 26 at the first end 108. Where it is desired to rotate the blade 26 to a sharp end, only partial case member 112 need be removed.

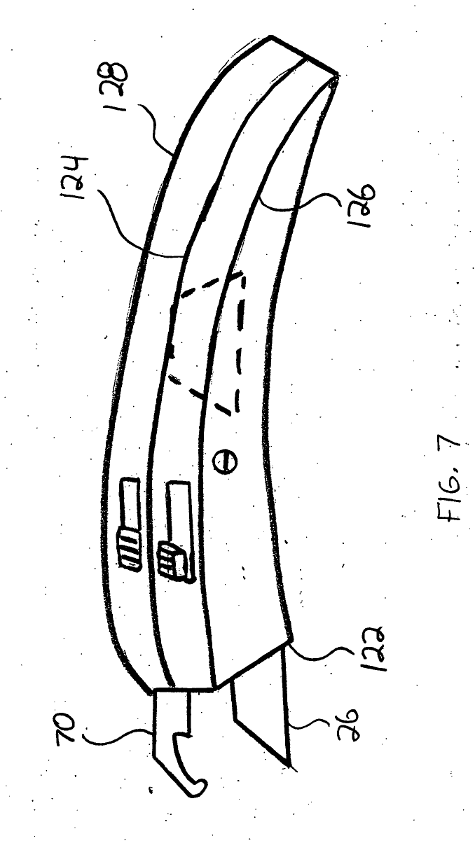

Looking now at FIG. 7, there is shown yet another embodiment of a utility knife handle 120 of the present invention wherein either of a pair of blades 26 and 70 can be extended or retracted from the same knife end 122. An intermediate casing 124 having equal and opposite sides mates with a first and second outer casing 126 and 128. As such the pair of parallel situate blades 26 and 70 are disposed along each side of the intermediate casing 124 at the first knife handle end 122. The storage recess of the prior art allows extra unused blades to be stored in an upright position along either or both sides of the intermediate casing 124. Either blade 26 or 70 can be changed by simply removing one of the outer casings 126 or 128.

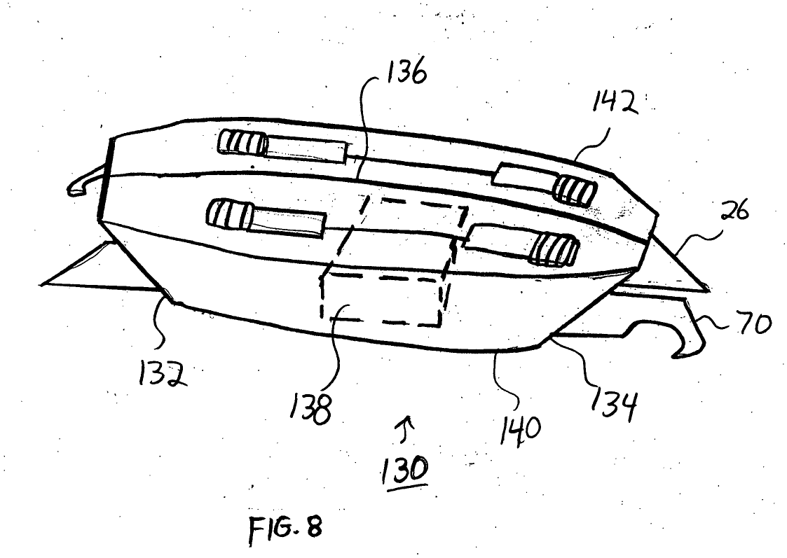

Turning now to FIG. 8, there is shown still another embodiment of a utility knife handle 130 of the present invention wherein either of a pair of blades 26 and 70 can be extended or retracted from both of the knife ends 132 and 134. An intermediate casing 136 which has equal and opposite sides, wherein each side is substantially similar to the casing 12 shown in FIG. 2, mates between a pair of outer casings 140 and 142.

The intermediate casing 136 includes an opening 138 there through which allows extra unused blades to be laterally inserted. Therefore, when either of the outer casing 140 and 142 are removed for blade replacements, the storage blades are accessible.

Where it is desirable to identify differing blade ends in the utility knife handle 10, one end of the handle 10 can be of a first color, while the second end can be of a second color. Alternatively, different types of identifying insignia can be used to quickly identify different handle ends.

While the preferred embodiments of the invention have been particularly described in the specification and illustrated in the drawings, it should be understood that the invention is not so limited. Many modifications, equivalents and adaptations of the invention will become apparent to those skilled in the art without departing from the spirit and scope of the invention as defined in the appended claims.

1. A utility knife handle comprising:
a first case having a longitudinal axis;
a second case which mates with said first case to form a handle;
a first blade opening disposed at a first longitudinal end of said handle;
a second blade opening disposed at a second longitudinal end of said handle;
a first blade securing means disposed adjacent to the first longitudinal end of said handle for securing a first blade;
a second blade securing means disposed adjacent to the second longitudinal end of said handle for securing a second blade, wherein said first blade securing means and said second blade securing means both orient the first and second knife blades in the same direction; and
a blade storage means disposed between said first and second blade securing means.

2. The utility knife handle of claim 1 further including a blade storage means for storing at least one extra blade.

3. The utility knife handle of claim 1, wherein said blade storage means further includes a blade storage cavity having a blade planar axis normal the longitudinal axis of the knife handle.

4. The utility knife handle of claim 1, wherein said blade storage means further includes an upright blade planar axis storage recess disposed between said first and second blade securing means.

5. The utility knife handle of claim 1, wherein said first blade securing means further includes a slidable blade track such that said first blade can be alternated between a sheathed and unsheathed position.

6. The utility knife handle of claim 1, wherein said first blade securing means further includes a plurality of static protrusions that mate with a plurality of notches of said first blade such that said first blade is always in an unsheathed position.

7. The utility knife handle of claim 3, wherein said second casing further includes a first casing member and a second casing member.

8. The utility knife handle of claim 4, wherein said second casing further includes a first casing member, a second casing member and a third casing member.

9. The utility knife handle of claim 1, wherein said first and second longitudinal end include differing identifying insignia.

10-18. (canceled)
